(19) United States
(12) Patent Application Publication
(10) Pub. No.: US 2002/0109880 A1
(43) Pub. Date: Aug. 15, 2002

(54) Method and apparatus for switching wavelength-division-multiplexed optical signals

(76) Inventors: Biswanath Mukherjee, Davis, CA (US); Vijayachandran Bobin, Sunnyvale, CA (US)

Correspondence Address: PARK, VAUGHAN & FLEMING LLP, 508 SECOND STREET, SUITE 201, DAVIS, CA, 95616, US

(21) Appl. No.: 09/780,211

(22) Filed: Feb. 9, 2001

(51) Int. Cl. H04J 14/02

(52) U.S. Cl. 359/128; 359/124

(57) ABSTRACT

On embodiment of the present invention provides a system for switching wavelength-division-multiplexed (WDM) optical signals. This system operates by receiving a plurality of optical input signals, and performing wavelength-division demultiplexing on each of the plurality of optical input signals to produce wavelength-specific input signals. These wavelength-specific input signals are grouped into a plurality of wave groups, wherein each wave group can include wavelength-specific input signals for more than one wavelength. The system then feeds these wavelength-specific input signals into a plurality of non-blocking switches, so that each non-blocking switch receives wavelength-specific input signals belonging to a specific wave group. Next, the system switches the wavelength-specific input signals within the plurality of non-blocking switches to produce wavelength-specific output signals that also belong to specific wave groups. Finally, the system performs wavelength-division multiplexing on the wavelength-specific output signals to produce a plurality of optical output signals. In one embodiment of the present invention, feeding the wavelength-specific input signals into the plurality of non-blocking switches involves feeding each wavelength-specific input signal through at most one non-blocking switch.

### BACKGROUND

1. Field of the Invention

The present invention relates to optical communication networks. More specifically, the present invention relates to a method and an apparatus for implementing an optical cross-connect for switching wavelength-division-multiplexed (WDM) optical signals.

2. Related Art

The explosive growth of the Internet and the recent proliferation of data-intensive applications, such as video-on-demand, have placed increasing demands on the existing network infrastructure. In order to keep pace with these increasing demands, communication networks have begun to use optical fibers to carry information. In order to utilize the full capacity of an optical fiber, data is often simultaneously transmitted on multiple wavelength-division-multiplexed (WDM) channels, wherein each WDM channel is transmitted on its own wavelength.

Simultaneously transmitting multiple data signals on different wavelengths greatly increases the capacity of an optical fiber. However, it also significantly complicates the problem of switching signals at the junction points between optical fibers.

Fiber optical networks are typically comprised of a number of optical cross-connects (OXCs) that are coupled together through optical fibers (for example, see FIG. 2). A message from a source is typically routed across a number of different optical fibers and a number of different optical cross-connects before arriving at a destination.

Each of these optical cross-connects switches signals between the different optical fibers. An exemplary optical cross-connect appears in FIG. 1. In this exemplary optical cross-connect, a number of optical fibers 122-125 feed into a number of demultiplexers 102-105. Demultiplexers 102-105 separate different wavelength-specific channels of data from the optical fibers, and the wavelength-specific channels of data are fed through a multi-stage Clos network containing non-blocking switches. Outputs of the non-blocking switches feed into multiplexers 112-115, which convert the outputs back into WDM optical signals. Note that the non-blocking switches in the first stage of the Clos network are used to switch 16 input signals into 31 output signals. This provides redundant communication pathways that allow more flexibility in routing signals through the optical cross-connect.

Also, note that the number of non-blocking switches in the Clos network is very large. If each non-blocking switch requires its own semiconductor chip, 159 semiconductor chips are required to implement the Clos network illustrated in FIG. 1. This large number of semiconductor chips greatly increases the size and cost of an optical cross-connect, and the number of interconnections within the Clos network, as well as increasing power consumption. Hence, large optical cross-connects that employ a multistage network tend to be expensive to produce and expensive to operate.

What is needed is a method and an apparatus for switching WDM optical signals without requiring the large numbers of switching elements found in a multistage switching network.

### SUMMARY

One embodiment of the present invention provides a system for switching wavelength-division-multiplexed (WDM) optical signals. This system operates by receiving a plurality of optical input signals, and performing wavelength-division demultiplexing on each of the plurality of optical input signals to produce wavelength-specific input signals. These wavelength-specific input signals are grouped into a plurality of wave groups, wherein each wave group can include wavelength-specific input signals for more than one wavelength. The system then feeds these wavelength-specific input signals into a plurality of non-blocking switches, so that each non-blocking switch receives wavelength-specific input signals belonging to a specific wave group. Next, the system switches the wavelength-specific input signals within the plurality of non-blocking switches to produce wavelength-specific output signals that also belong to specific wave groups. Finally, the system performs wavelength-division multiplexing on the wavelength-specific output signals to produce a plurality of optical output signals.

In one embodiment of the present invention, feeding the wavelength-specific input signals into the plurality of non-blocking switches involves feeding each wavelength-specific input signal through at most one non-blocking switch.

In one embodiment of the present invention, the system additionally receives wavelength-specific signals at an add switch. This add switch switches the plurality of wavelength-specific signals to produce a plurality of outputs that are grouped into the plurality of wave groups. The system then routes the plurality of outputs to the plurality of non-blocking switches, so that outputs belonging to a specific wave group are directed to a specific non-blocking switch associated with a specific wave group. The system also routes a subset of the wavelength-specific output signals from the plurality of non-blocking switches to a drop switch. This drop switch switches the subset of the wavelength-specific output signals to produce outputs. In a variation on this embodiment, the add switch receives wavelength-specific signals from at least one edge device. In a variation on this embodiment, the add switch receives wavelength-specific signals from at least one WDM demultiplexer. In a variation on this embodiment, the system routes outputs from the drop switch to at least one edge device. In a variation on this embodiment, the system routes outputs from the drop switch to at least one WDM multiplexer.

In one embodiment of the present invention, the system converts wavelength-specific input signals from optical form into electrical form prior to reaching the plurality of non-blocking switches. The system also performs the reverse operation and converts the wavelength-specific output signals from the plurality of non-blocking switches from electrical form into optical form.

In one embodiment of the present invention, the system performs wavelength-division demultiplexing by using a plurality of WDM demultiplexers. In this embodiment, each of the plurality of WDM demultiplexers directs at least one wavelength-specific input signal into each of the plurality of non-blocking switches.

In one embodiment of the present invention, the system performs wavelength-division multiplexing by using a plurality of WDM multiplexers. In this embodiment, each of the plurality of WDM multiplexers receives at least one wavelength-specific output signal from each of the plurality of non-blocking switches.

In one embodiment of the present invention, each of the plurality of non-blocking switches is a crossbar switch.

In one embodiment of the present invention, the plurality of optical input signals are received from a plurality of neighboring nodes in an optical network. Similarly, the plurality of optical output signals are directed to the plurality of neighboring nodes in the optical network.

### BRIEF DESCRIPTION OF THE FIGURES

FIG. 1 illustrates a prior art optical cross-connect.

FIG. 2 illustrates a network of optical cross-connects in accordance with an embodiment of the present invention.

FIG. 3 illustrates an optical cross-connect with a single stage of switching elements in accordance with an embodiment of the present invention.

FIG. 4 is a flow chart illustrating the process of setting up a call across an optical network in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Optical Network

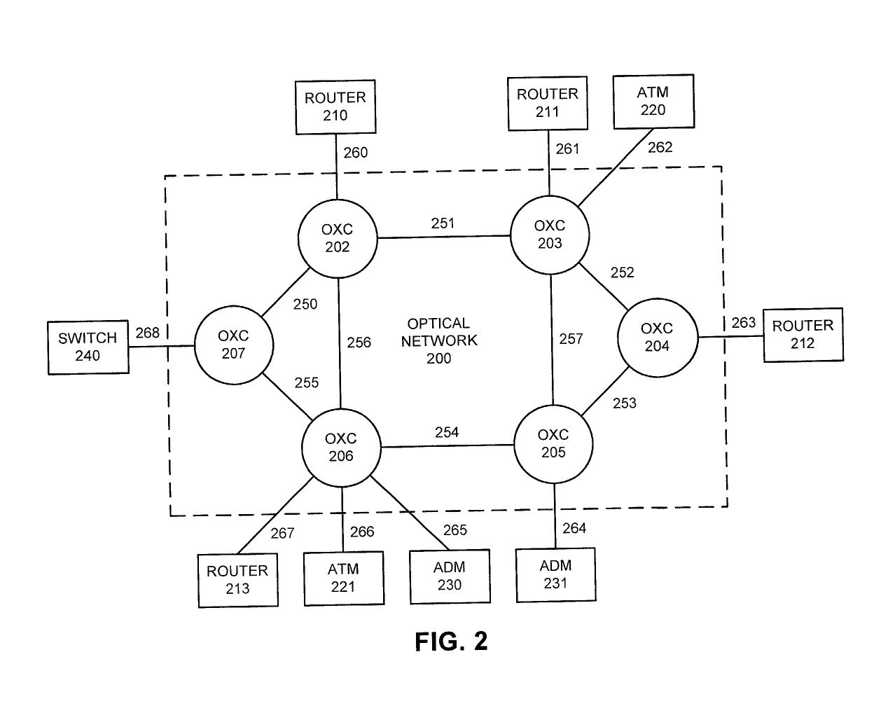

FIG. 2 illustrates an optical network 200 containing optical cross-connects 202-207 (OXCs) in accordance with an embodiment of the present invention. Optical cross-connects 202-207 are coupled to each other through a number of communications links 250-257. Each of these communication links 250-257 contains one or more optical fibers that carry wavelength-division multiplexed (WDM) signals between optical cross-connects 202-207.

Note that optical cross-connects 202-207 can be coupled to “edge devices,” such as Internet protocol (IP) routers 210-213, add-drop multiplexers (ADMs) 230-231, asynchronous transfer mode (ATM) switches 220-221, and other switches 240. Each of these edge devices is coupled either directly or indirectly to a number of computer systems or communications devices that send and receive communications through optical network 200.

By appropriately performing routing and wavelength assignments through optical cross-connects 202-207, an optical connection can be established to create logical (or virtual) neighbors out of edge devices that are geographically far apart in the network. For example, an optical connection can be established from router 213 to router 211 by establishing a connection that passes through communication link 267, optical cross-connect 206, communication link 254, optical cross-connect 205, communication link 257, optical cross-connect 203 and communication link 261. At each optical cross-connect along the way it is possible to switch the connection to a different wavelength on a different communication link.

Note that point-to-point optical connections are referred “lightpaths”, while point-to-multi-point optical connections are called “light-trees”. Also note that lightpaths can be both unidirectional and bi-directional.

Optical Cross-Connect with Single Stage of Switching Elements

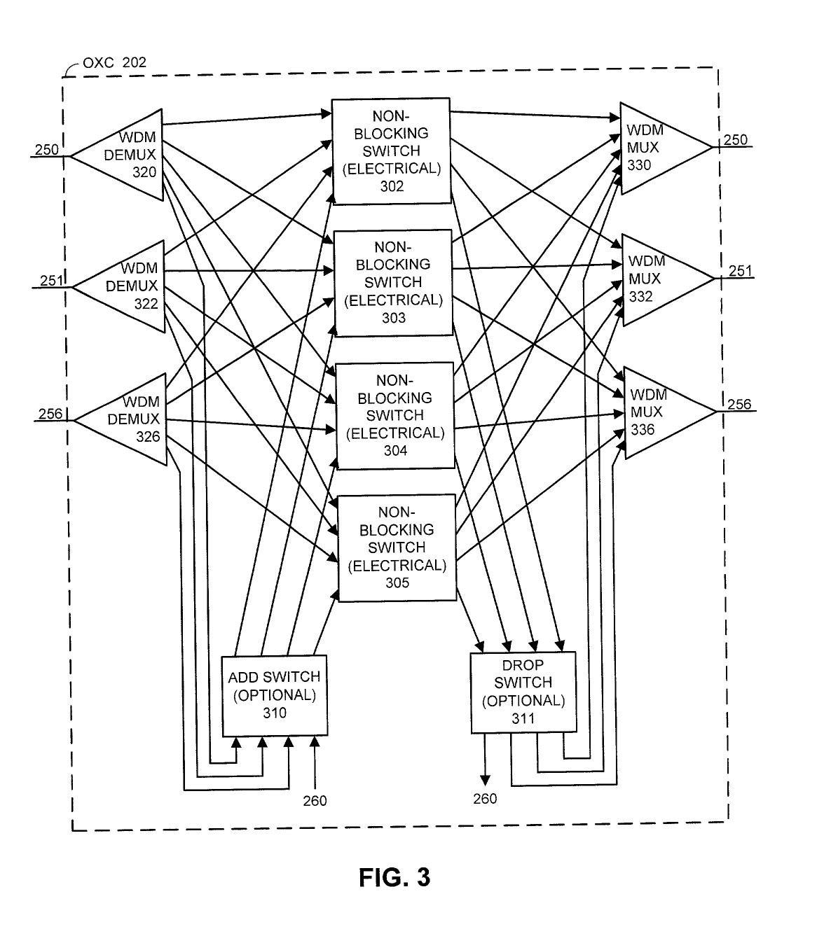

FIG. 3 illustrates an exemplary optical cross-connect 202 with a single stage of non-blocking switches in accordance with an embodiment of the present invention. Optical cross-connect 202 communicates through communication link 250 to optical cross-connect 207; through communication link 256 to optical cross-connect 206; and through communication link 251 to optical cross-connect 203. Optical cross-connect 203 also communicates with router 210 through communication link 260.

On the left-hand-side of FIG. 3, optical fibers from communication links 250, 251 and 256 feed into WDM demultiplexers 320, 322 and 326, respectively. Each of these WDM demultiplexers 320, 322 and 326 separates signals on different WDM channels carried on different frequencies on the optical fiber into separate outputs. These outputs are divided into a plurality of “wave groups,” which include signals from one or more wavelengths. Signals for a given wavegroup are all routed to an associated non-blocking switch.

For example, in FIG. 3 WDM demultiplexers 320, 322 and 326 produce outputs that are divided into four wavegroups, and each wavegroup is directed to an associated one of the four non-blocking switches 302-305. Although FIG. 3 illustrates only one signal from each WDM demultiplexer being directed to each non-blocking switch, in general multiple signals associated with multiple wavelengths are directed from each WDM multiplexer to each non-blocking switch.

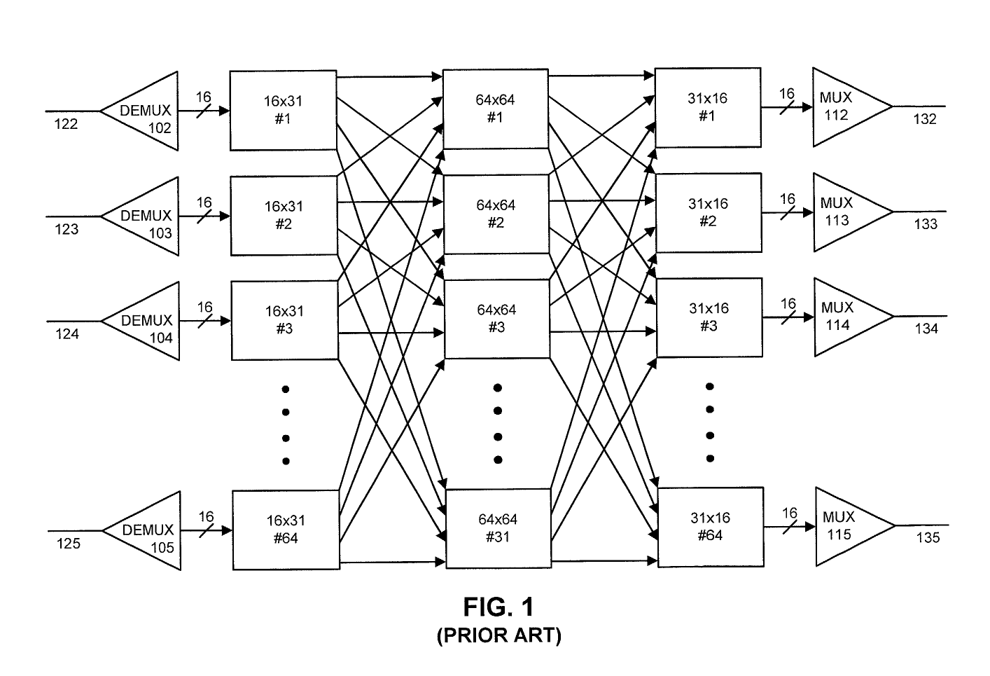

In the embodiment of the present invention illustrated in FIG. 1, the non-blocking switches are electrical. This means that a conversion between optical and electrical signals takes place at some point between WDM demultiplexers 320, 322 and 326 and non-blocking switches 302-305.

In one embodiment of the present invention, each of the WDM demultiplexers 320, 322 and 326 converts a WDM signal into a plurality of 1310 nanometer (nm) optical signals, wherein there is a separate 1310 nm optical signal for each WDM channel. (Note that instead of 1310 nm signals, different wavelength signals can also be used, such as 850 nm signals or 1510 nm signals.) Next, each of these 1310 nm optical signals feeds into a converter that converts the 1310 nm optical signal into an electrical signal that feeds into one of non-blocking switches 302-305.

Non-blocking switches 302-305 are used to switch inputs received from WDM demultiplexers 320, 322 and 326 into output signals that are distributed to WDM multiplexers 330, 332 and 336. In one embodiment of the present invention, non-blocking switches 302-305 are implemented using cross-bar switches.

WDM multiplexers 330, 332 and 336 convert the outputs of non-blocking switches 302-305 back into WDM optical form to produce WDM optical signals that feed through communication links 250, 251 and 256 to neighboring optical cross-connects, 207, 203 and 206, respectively. Note that at some point between non-blocking switches 302-305 and WDM multiplexers 330, 332 and 336, the electrical signals from non-blocking switches 302-305 are converted back into single-wavelength optical form.

Add/Drop Switches

The optical cross-connect illustrated in FIG. 3 can be optionally augmented to include add switch 310 and drop switch 311. Add switch 310 can receive inputs from WDM demultiplexers 320, 322 and 326, as well as from communication link 260 going to an edge device, such as router 210 (see FIG. 2). Add switch 310 switches these input signals to produce output signals that are routed to non-blocking switches 302-305.

Some of the outputs of non-blocking switches 302-305 become inputs to drop switch 311. Drop switch 311 switches these inputs to produce outputs that are directed to WDM multiplexers 330, 332 and 336, as well as to communication link 260, which is coupled to router 210.

Note that the combination of add switch 310 and drop switch 311 provide additional pathways through optical cross-connect 202 that can be used to augment the pathways that pass through only a single non-blocking switch.

Advantages

The new optical cross-connect illustrated in FIG. 3 has a number of advantages when compared with the prior art multistage network illustrated in FIG. 1. The new optical cross-connect uses considerably fewer chips and considerably fewer interconnections, which results in a much cheaper switch, which is easier to maintain. Of course, since the new switch has fewer redundant pathways it is more likely to block when the system attempts to establish a given connection. However, this blocking problem can often be overcome by carefully optimizing routes through multiple optical cross-connects within an optical network.

The present invention also has considerable advantages over solutions that use completely optical switching elements instead of electrical switches 302-305. This is because completely optical switching elements are constrained to switch signals that belong to the same wavelength, whereas the present invention can be used to establish connections between different wavelengths on different optical fibers. This is possible because each wavegroup generally contains signals from a number of different wavelengths. Hence, each non-blocking switch can be used to switch signals between the different wavelengths in the associated wave group.

Implementation

Note that an implementation of the present invention is generally larger than the example illustrated in FIG. 3. For example, in one embodiment of the present invention, an optical cross-connect that switches 1024 inputs between 1024 outputs is built out of a single column of eight 128×128 non-blocking switching elements. This optical cross-connect receives eight WDM optical inputs, and each of these WDM optical inputs is demultiplexed into 128 single-wavelength optical signals that feed into the 128×128 non-blocking switching elements. The outputs of the eight 128×128 non-blocking switching elements feed into eight 128-to-one WDM multiplexers.

In this embodiment, each of the eight WDM demultiplexers sends 16 single-wavelength inputs to each of the 128×128 switching elements. Conversely, each the of the eight 128×128 non-blocking switching elements sends 16 single-wavelength output signals to each of the 128-to-one WDM multiplexers.

In another embodiment of the present invention, one of the eight WDM demultiplexers is replaced with an add switch that receives inputs from the remaining seven WDM demultiplexers, as well as from various edge devices. Outputs from the add switch are routed to the eight 128×128 non-blocking switches. Similarly, one of the eight WDM multiplexers is replaced by a drop switch that receives input signals from the eight 128×128 non-blocking switches. Outputs from the drop switch are routed to the remaining seven 128-to-one multiplexers, as well as to the various edge devices.

Call Setup Process

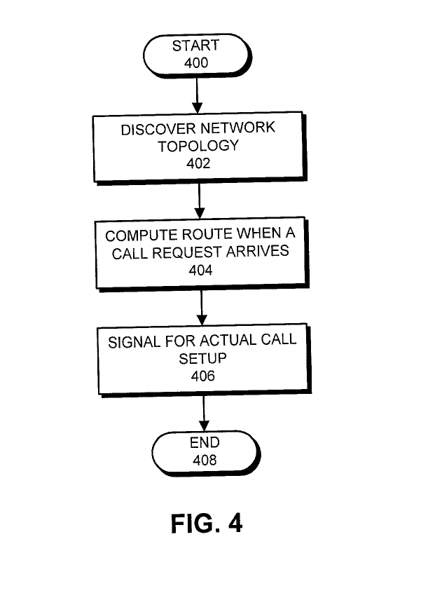

FIG. 4 is a flow chart illustrating the process of setting up a call across optical network 200 in accordance with an embodiment of the present invention. The system starts by discovering the network topology, which can be accomplished through use of the Open Shortest Path First (OSPF) protocol (step 402). Next, when a call request arrives, the system computes a route for the call (step 404). This generally involves computing a route through multiple optical-cross-connects that comprise optical network 200. Finally, the system sets up a call by signaling for a call setup using the Multi-Protocol Label Switching (MPLS) protocol (step 406). At this point the call (or connection) is established across optical network 200.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus for switching wavelength-division-multiplexed (WDM) optical signals, comprising:
a plurality of optical input signals;
a plurality of optical output signals;
a plurality of WDM demultiplexers, wherein each of the plurality of optical input signals is coupled to one of the plurality of WDM demultiplexers, so that the WDM demultiplexer converts the optical input signal into a plurality of wavelength-specific input signals;
wherein the plurality of wavelength-specific input signals are grouped into a plurality of wave groups, wherein each wave group can include wavelength-specific input signals for more than one wavelength;
a plurality of non-blocking switches, wherein each non-blocking switch is configured to receive wavelength-specific input signals belonging to a specific wave group from the plurality of WDM demultiplexers, and to switch these wavelength-specific input signals to produce wavelength-specific output signals that also belong to the specific wave group; and
a plurality of WDM multiplexers, wherein each of the plurality of WDM multiplexers receives a plurality of wavelength-specific output signals from the plurality of non-blocking switches and combines the plurality of wavelength-specific output signals into a single optical output signal within the plurality of optical output signals.

2. The apparatus of claim 1, wherein at most one of the plurality of non-blocking switches resides on most pathways between the plurality of WDM demultiplexers and the plurality of WDM multiplexers.

3. The apparatus of claim 2, further comprising:
an add switch that is configured to receive a plurality of wavelength-specific signals and to switch the plurality of wavelength-specific signals to produce outputs that are grouped into the plurality of wave groups;
wherein the outputs of the add switch feed into the plurality of non-blocking switches so that outputs belonging to a specific wave group are directed to a specific non-blocking switch associated with the specific wave group; and
a drop switch that is configured to receive a plurality of wavelength-specific outputs from the plurality of non-blocking switches and to switch the plurality of wavelength-specific outputs to produce drop switch outputs.

4. The apparatus of claim 3, wherein the add switch is configured to receive inputs from at least one edge device coupled to the apparatus.

5. The apparatus of claim 3, wherein the add switch is configured to receive inputs from the plurality of WDM demultiplexers.

6. The apparatus of claim 3, wherein the drop switch is configured to direct drop switch outputs to at least one edge device coupled to the apparatus.

7. The apparatus of claim 3, wherein the drop switch is configured to direct drop switch outputs to the plurality of WDM multiplexers.

8. The apparatus of claim 1, further comprising:
a plurality of optical-to-electrical converters that are configured to convert the plurality of wavelength-specific input signals from optical form into electrical form prior to reaching the plurality of non-blocking switches; and
a plurality of electrical-to-optical converters that are configured to convert the plurality of wavelength-specific output signals from optical form into electrical form prior to reaching the plurality of WDM multiplexers.

9. The apparatus of claim 1,
wherein each of the plurality of WDM demultiplexers directs at least one wavelength-specific input signal into each of the plurality of non-blocking switches; and
wherein each of the plurality of WDM multiplexers receives at least one wavelength-specific output signal from each of the plurality of non-blocking switches.

10. The apparatus of claim 1, wherein each of the plurality of non-blocking switches is one of, a crossbar switch and a multi-stage network.

11. The apparatus of claim 1,
wherein the plurality of optical input signals are received from a plurality of neighboring nodes in an optical network; and
wherein the plurality of optical output signals are directed to the plurality of neighboring nodes in the optical network.

12. An optical network, comprising a plurality of optical cross-connects that are coupled together to form the optical network, wherein each optical cross-connect includes:
a plurality of optical input signals;
a plurality of optical output signals;
a plurality of WDM demultiplexers, wherein each of the plurality of optical input signals is coupled to one of the plurality of WDM demultiplexers, so that the WDM demultiplexer converts the optical input signal into a plurality of wavelength-specific input signals;
wherein the plurality of wavelength-specific input signals are grouped into a plurality of wave groups, wherein each wave group can include wavelength-specific input signals for more than one wavelength;
a plurality of non-blocking switches, wherein each non-blocking switch is configured to receive wavelength-specific input signals belonging to a specific wave group from the plurality of WDM demultiplexers, and to switch these wavelength-specific input signals to produce wavelength-specific output signals that also belong to the specific wave group; and
a plurality of WDM multiplexers, wherein each of the plurality of WDM multiplexers receives a plurality of wavelength-specific output signals from the plurality of non-blocking switches and combines the plurality of wavelength-specific output signals into a single optical output signal within the plurality of optical output signals.

13. The optical network of claim 12, wherein at most one of the plurality of non-blocking switches resides on most pathways between the plurality of WDM demultiplexers and the plurality of WDM multiplexers.

14. A method for switching wavelength-division-multiplexed (WDM) optical signals, comprising:
receiving a plurality of optical input signals;
performing wavelength-division demultiplexing on each of the plurality of optical input signals to produce a plurality of wavelength-specific input signals;
grouping the plurality of wavelength-specific input signals into a plurality of wave groups, wherein each wave group can include wavelength-specific input signals for more than one wavelength;
feeding the plurality of wavelength-specific input signals into a plurality of non-blocking switches, so that each non-blocking switch receives wavelength-specific input signals belonging to a specific wave group;
switching the plurality of wavelength-specific input signals within the plurality of non-blocking switches to produce a plurality of wavelength-specific output signals that also belong to specific wave groups; and
performing wavelength-division multiplexing on the plurality of wavelength-specific output signals to produce a plurality of optical output signals.

15. The method of claim 14, wherein feeding the wavelength-specific input signals into the plurality of non-blocking switches involves feeding most wavelength-specific input signals through at most one non-blocking switch.

16. The method of claim 15, further comprising:
receiving a plurality of wavelength-specific signals at an add switch;
switching the plurality of wavelength-specific signals at the add switch to produce a plurality of outputs that are grouped into the plurality of wave groups;
routing the plurality of outputs to the plurality of non-blocking switches, so that outputs belonging to a specific wave group are directed to a specific non-blocking switch associated with a specific wave group;
routing a subset of the plurality of wavelength-specific output signals from the plurality of non-blocking switches to a drop switch; and
switching the subset of the plurality of wavelength-specific output signals at the drop switch to produce outputs.

17. The method of claim 16, wherein receiving the plurality of wavelength-specific signals at the add switch involves receiving wavelength-specific signals from at least one edge device.

18. The method of claim 16, wherein receiving the plurality of wavelength-specific signals at the add switch involves receiving wavelength-specific signals from at least one WDM demultiplexer.

19. The method of claim 16, further comprising routing outputs from the drop switch to at least one edge device.

20. The method of claim 16, further comprising routing outputs from the drop switch to at least one WDM multiplexer.

21. The method of claim 14, further comprising:
converting the plurality of wavelength-specific input signals from optical form into electrical form prior to reaching the plurality of non-blocking switches; and
converting the plurality of wavelength-specific output signals from the plurality of non-blocking switches from electrical form into optical form.

22. The method of claim 14,
wherein performing wavelength-division demultiplexing involves using a plurality of WDM demultiplexers;
wherein each of the plurality of WDM demultiplexers directs at least one wavelength-specific input signal into each of the plurality of non-blocking switches;
wherein performing wavelength-division multiplexing involves using a plurality of WDM multiplexers; and
wherein each of the plurality of WDM multiplexers receives at least one wavelength-specific output signal from each of the plurality of non-blocking switches.

23. The method of claim 14, wherein each of the plurality of non-blocking switches is one of, a crossbar switch and a multi-stage network.

24. The method of claim 14,
wherein the plurality of optical input signals are received from a plurality of neighboring nodes in an optical network; and
wherein the plurality of optical output signals are directed to the plurality of neighboring nodes in the optical network.
